(19) United States
(12) Patent Application Publication
(10) Pub. No.: US 2006/0251831 A1
(43) Pub. Date: Nov. 9, 2006

(54) Ink-jet recording medium

(76) Inventors: Takehiko Nishikawa, Warabi-shi (JP); Kenji Harada, Warabi-shi (JP); Hitoshi Fujii, Kyoto-shi (JP); Shigeru Nawa, Kyoto-shi (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/398,870

(22) Filed: Apr. 6, 2006

(30) Foreign Application Priority Data
Apr. 11, 2005 (JP) 2005-113170

(51) Int. Cl. B41M 5/00

(52) U.S. Cl. 428/32.24

(57) ABSTRACT

The present invention provides an ink-jet recording medium for use in industrial ink-jet printers which offers good printability and storage stability for outdoor and indoor applications. The ink-jet recording medium comprises an ink-absorption layer that absorbs the largest amount of ink of all the layers that constitute an ink-receiving layer on at least one surface of the substrate is composed of a material comprising porous pigment, a fixer and a binder, in which the fixer is an amphoteric fixer containing a cationic component that is cationic and an anionic component that is anionic, in which the molar ratio of the cationic component to the anionic component contained in the fixer is in the range between 1:0.01 and 1:0.5, and in which the percentage of the fixer contained in the ink-absorption layer ranges from 1 to 30% by weight of the solid content of the ink-absorption layer. Printed matter obtained by ink-jet printing on the ink-jet recording medium of the present invention has excellent durability, such as long-term image quality, water resistance and heat resistance.

### BACKGROUND OF THE INVENTION

1. Field of the Invention

The ink-jet recording medium of the present invention relates to an ink-jet recording medium used in the so-called ink-jet recording method comprising discharging dye-based ink or pigment-based ink from an ink-jet orifice and forming an image by spraying ink droplets discharged from the orifice onto the recording medium.

2. Description of the Related Art

Ink-jet recording methods have a very wide spectrum of applications, including printing of general office documents, printing of telephone bill, printing on the surface of cardboards and ink jet thermal transfer printing for transferring and decorating fabric substrates, such as T-shirts, in the output devices of personal computers. In general, ink-jet recording methods include thermal printing methods, which use vapor pressure generated by heating to discharge ink from ink reservoirs such as ink cartridge through nozzles, and the piezo method, which uses piezo elements to convert electric signals into pressure thereby discharging ink. These methods are characterized in that discharged ink droplets are sprayed onto a recording medium, such as paper and cloth, thereby forming an image without contact of medium with the print head. In recent years, printers have been developed which ejects ink droplets in a volume reduced to a few picolitters. Printers whose resolution of recorded images is over 1440 dot/inch are also been developed. On the other hand, in the industrial applications, technologies for improving print speed have been advanced, and high-speed printers whose printing speed is 100 to 150 m per minute have been developed and are in practical use. Ink used for ink-jet recording is a dye-based ink, in which color material such as an acid dye is dissolved in a solvent, such as water and alcohol, or a pigment-based ink, in which a coloring pigment is dispersed in water or alcohol. Some printers use both types of ink, depending on color. Also, there are solvent-type media which use, as a solvent or dispersion medium, a quick-drying solvent such as methylethylketone, in stead of water and alcohol, for enhancing drying properties.

In recent years, for such a variety of ink-jet printers, a large number of ink-jet recoding medium have been developed and are in use. An extremely wide variety of ink-jet recoding medium are manufactured and commercially available, including plain paper, printer paper having an ink-receiving layer formed on a substrate such as paper and film, glossy paper, semi-glossy paper, fabric, nonwoven fabric. In such a wide variety of ink-jet recoding medium, to ensure clear printing with resolution of over 300 dot/inch, a variety of materials are used to compose recording media and are used in combination according to the use. Conventionally, it is common practice to form an ink-receiving layer according to the following procedure: dispersing a porous pigment, such as silica, in a water-soluble binder, such as polyvinyl alcohol, adding a cationic fixer capable of absorbing dye to the dispersion to obtain a coating material, and uniformly coating the substrate with the coating material using a roll coater, air-knife coater, gravure coater and blade coater and drying. There are also wide variety of silica, water-soluble binders and cationic fixers (see, for example, Japanese Laid-Open Patent Publication No. S60-204390 and Japanese Laid-Open Patent Publication No. S62-183382).

In particularly instead of conventional printers for office use, so-called wide format printers, capable of printing to a width of at least several hundred millimeters at a time, are used in the industrial field. They are used for indoor decorations, such as interior and wall materials, and for outdoor displays, such as banners and flags. Wide format ink-jet printers used for these purposes may use dye-based ink using a dye as a coloring component, or pigment-based ink using a pigment as a coloring component. These inks include water-based types, which comprise water and alcohol as the solvent, mild-solvent inks, which comprise ether as the major component, and oil-based inks, which comprise hydrocarbons as the major component. The following materials are often used as substrates for recording media for ink-jet recording: paper; film such as polyethylene terephthalate or polypropylene; fabric such as cotton or polyester; and non-woven fabric.

### SUMMARY OF THE INVENTION

The present invention mainly relates to an ink-jet recording medium for use in wide format printers, and an objective of the present invention is to provide an ink-jet recording medium with improved storage stability, such as long-term image quality and water resistance of ink-jet printed matter by forming an ink-receiving layer characteristic for each type of ink and solvent used in ink-jet printers as described above.

The ink-jet recording medium of the present invention comprises at least one ink-receiving layer provided on at least one surface of the substrate for receiving ink during ink jet printing. An ink-absorption layer of this medium that is one of the layers constituting the ink-receiving layer and absorbs the largest amount of ink is composed of a material comprising porous pigment, a fixer and a binder. The fixer is an amphoteric fixer containing a cationic component that is cationic and an anionic component that is anionic, and contains these components in the molar ratio of an amount of the cationic component to an amount of the anionic component in the range between 1:0.01 and 1:0.5. Further, the percentage of the fixer contained in the ink-absorption layer ranges from 1 to 30% by weight of the solid content of the ink-absorption layer.

The present invention is also characterized in that the cationic component of the ink-jet recording medium is at least one selected from the group consisting of diallyldimethyl ammonium salt, allylamine, dimethylaminoethyl methacrylate and dimethylaminoethyl acrylate.

The present invention is further characterized in that in the ink-jet recording medium provided with the above-described features, the cationic component is selected from a group consisting of diallyldimethyl ammonium salt, dimethylaminoethyl methacrylate and dimethylaminoethyl acrylate, the fixer is a mixture of a first fixing agent containing a diallyldimethyl ammonium salt as a cationic component and a second fixing agent containing either dimethylaminoethyl methacrylate or dimethylaminoethyl acrylate as a cationic component, and the mixing ratio of the first and second fixing agents is in the range between 5:1 and 1:5 by weight.

The present invention is also characterized in that in the ink-jet recording medium provided with the above-described features, the ink-absorption layer contains a polycarbonate polyurethane resin as the binder at a ratio of 5 to 50% by weight of the solid content of the ink-absorption layer.

The ink-jet recording medium of the present invention has improved storage stability, such as long-term image quality, water resistance and heat resistance of ink-jet printed materials. The printed materials obtained may be durable in outdoor and indoor environments.

### DETAILED DESCRIPTION OF THE INVENTION

The ink-jet recoding medium according to the present invention are comprised of at least a substrate and an ink-receiving layer provided on the substrate for abosorbing ink during ink-jet printing.

The substrate may be paper, plastic film such as polyethylene terephthalate or polypropylene, nonwoven fabric, fabric such as cotton or polyester, or a composite material in which a polymer such as polyethylene or polypropylene is attached by coating or laminating onto a substrate such as a sheet of paper or nonwoven fabric. The present invention is provided mainly for indoor and outdoor use of ink-jet printed materials, and the substrates per se are required to have durability such as heat resistance and water resistance. To satisfy these requirements, substrates are often used which are plastic film or paper coated with polymer. However, a substrate having a surface coated with a layer of polymer absorbs almost no ink during ink-jet printing. Thus, this leads to the restriction that almost all the ink should be absorbed only by the ink-receiving layer provided on the substrate. To meet this restriction, it is necessary to design the ink-receiving layer so that it has a sufficient volume of space formed by porous pigment. Further efforts are required to increase the density of the space by making the ink-receiving layer thicker than those made of ink absorbing materials such as conventional paper in order to increase the volume of the space, and by using a more adhesive bond.

The ink-receiving layer is formed on at least one surface of the substrate, namely on either or both surfaces of the substrate. The ink-receiving layer is composed of a single or a plurality of layers, among which the layer that absorbs the largest amount of ink is herein referred to as “ink absorption layer”. The present invention is characterized by the materials that form such an ink absorption layer.

The ink absorption layer is comprised of a porous pigment such as silica or calcium carbonate, a fixer that is an agent mainly for fixing a dye, a bonding agent (herein referred to as “binder”) for closely attaching the ink absorption layer to the substrate, and other additives, including an antifoaming agent and a leveling agent.

An inorganic or organic pigment with an average diameter of 0.1 to 30 μm is used as the porous pigment. As used herein, the term “porous” refers to the capability of pigment particles to produce numerous spaces between the particles by interparticle adhesion through a binder component, etc. In general, the ink-absorption performance of such porous pigments is measured using oil absorption according to JIS K5101 as an indication. The porous pigment used in the present invention is preferably a pigment having an oil absorption of 100 to 300 ml/100 g, more preferably a pigment having an oil absorption of 150 to 300 ml/100 g. If the oil absorption is too low, the ink-absorption performance may become poor, which cause ink bleeding and will make images blur. On the other hand, if the oil absorption is extremely high, the viscosity of the pigment dispersed in a solvent for coating treatment and the like increased too much. Such a pigment is not practical. Thus, the ink-absorption performance is used to express the ink-absorption capacity of porous pigments by oil absorption; however, needless to say, a porous pigment alone is not able to attach to its substrate or to allow adhesion between each other. It is a binder that confers adhesiveness. Typically, in the ink-jet field, the following materials have been used for constituting the binder: water-soluble resin such as polyvinyl alcohol, polyvinyl pyrrolidone or polyethylene oxide, ethylene-vinyl acetate copolymer, acrylic acid ester or copolymer thereof, polyurethane resin, etc. The present invention mainly relates to an ink-jet recording medium for use in wide format printers that may be used in both outdoor and indoor applications, and the medium is required to have excellent durability such as water resistance, heat resistance and light resistance, let alone printing performance. Therefore, the use of water-soluble resin, which is less water resistant, as a binder is not preferred. The use of synthetic resin having good heat resistance and heat yellowing resistance, i.e., synthetic resin that does not turn yellow by heating, is preferred. For such use, polyurethane resin, such as polyester polyurethane and polycarbonate polyurethane, and polyolefin polymer, such as ethylene-vinyl acetate copolymer are preferred, and the use of polycarbonate polyurethane is particularly preferred. The amount of the binder to be used may be 10 parts by weight to 100 parts by weight with respect to 100 parts by weight of porous pigment. If the amount is below this range, both attachment of the ink-receiving layer to the substrate and adhesion between pigment particles become poor. On the other hand, if the amount is greater than this range, proportion of the spaces formed by the porous pigment is reduced, resulting in poor ink absorption during ink-jet printing. Polycarbonate polyurethane, a particularly preferred binder in the present invention, is a reaction product of a polycarbonate polyol with a polyfunctional isocyanate, and has excellent ink absorption capacity, excellent durability such as heat resisntace, excellent coloring quality in ink-jet applications. Ink-jet recoding medium using this binder for the ink-receiving layer show excellent carrying property. However, in general, adhesion performance of this binder tends to be lower than that of acryl or ethylene-vinyl acetate copolymer. In the present invention, the amount of polycarbonate polyurethane to be contained in the ink-absorption layer is preferably 5 to 50% by weight. If the amount is greater than this range, it is difficult to balance between printability and durability. If the amount is below this range, it is difficult to sustain the adhesion of the porous pigment and the attachment to the substrate of the ink-absorption layer in a sufficient manner.

In the present invention, a fixer is used as one of the components constituting the ink absorption layer, and the fixer is characterized by being a so-called amphoteric fixer composed of cationic and anionic components. In the ink-receiving layer of conventional ink-jet recoding medium, cationic fixers are often used. However, fixers composed of only cationic components often cause problems in compatibility with pigment, including aggregation. Because the surfaces of silica and calcium carbonate used as porous pigments are usually anionic and complexes are often formed between the anionic groups of these compounds and the cationic group of the fixer. Of course, there is a particular sort of pigment that forms cationic groups on its surface by surface treatment of the pigment per se. Such cationic surface-treated pigments have good compatibility with cationic fixers, but they have a drawback of being expensive due to surface treatment. Some sorts of pigments cannot be cationized.

Due to good compatibility with porous pigments, such as silica and calcium carbonate, having anionic surfaces, the amphoteric fixers used in the present invention bear the following characteristic features. First, although the ink-receiving layer is typically formed by coating using a coating machine and the like, coating suitability of a coating material is improved when the material of the ink-receiving layer is used as the coating material as a coating agent. Porous pigments strongly act to increase the viscosity of coating materials during the processing to produce the coating material. In particular, when the dispersibility of the pigment in the coating material is insufficient, the viscosity of the coating material will increase or the storage stability of the coating material will be reduced thereby forming precipitates of the pigment. Second, the solid concentration of the coating material can be increased when the dispersibility of the pigment is improved. In general, for a coating material using a porous pigment with an oil absorption of around 200 ml/100 g, the solid concentration of the coating material is 15 to 25%, or 30% at most. However, the solid concentration of the coating material may be increased up to about 40% by using the amphoteric fixers disclosed in the present invention. This allows for increasing the amount of coating material to be coated using a coating machine. In particular, when the substrate is surface-treated with a plastic film or polymer, such as polyethylene terephthalate or polypropylene, the substrate per se absorbs almost no ink-jet ink, and the thickness of the ink absorption layer must be increased. In this situation, the thickness of the ink absorption layer is generally required to be 30 μm to 50 μm, although it may depend on the ink discharge rate from the printer model. To achieve this thickness by a single coating, it is necessary to increase the coating concentration as high as possible. Coating machines that are used to apply a thick coating material include coaters with a roll knife coater head and die coaters. The amount of coating material applied using these machines is up to about 100 μm in the coating material state. Therefore, to ensure the thickness of the ink absorption layer, the solid concentration of the coating material must be 30 to 50%. Moreover, the viscosity of the coating material in a roll knife coater or a die coater is desirably in the range between 1000 mPa·s and 3000 mPa·s. If the viscosity is too low, the coating material may drip down after application or uneven coating may result, and application of a stable amount of coating material cannot be ensured. If the concentration of the coating material is too high, delivery of liquid to the coater head may be impaired, and the flow of the coating material may be disturbed, thereby deteriorating the surface profile due to uneven application of the coating material.

In the present invention, to form an ink absorption layer on the substrate, coating of the substrate by any of the above-mentioned coating machines is assumed. In addition to coating machines, there are other printing methods such as flexographic printing and screen printing. However, since the printing thickness of 10 μm is near the upper limit, it is difficult to form an ink absorption layer with a sufficient thickness. Although the coating methods include air knife coating, bar coating, blade coating, roll knife coating and die coating. The amount of coating material applied is relatively small in air knife coating and blade coating, and it is difficult to form an ink-absorption layer by a single application. Multilayer coating more than two layer coating is thus necessitated. However, in general, if a porous coating layer containing porous pigment is coated twice, air present in the first coating layer forms bubbles which penetrate to the surface of the top coating layer. In this process, traces of the bubbles remain on the surface of the top coating layer, resulting in uneven coating. For these reasons, it is desirable to form an ink absorption layer by a single application of the coating material. A coating machine for this purpose is desirably a roll knife coater or a die coater as mentioned above.

With respect to the chemical structure of the amphoteric fixers used in the present invention, a cationic fixer for ink-jet printing is suitable as the cationic component. Conventionally, the cationic components include polyethylenimine salts, dimethylamine epihalohydrin condensation products, polyvinylamine salts, polyallylamines, polydimethylaminoethyl methacrylate, polydiallyldimethylammonium salts, diallylamine-acrylamide copolymer, polystyrene quaternary ammonium salts, and dicyandiamide polyalkylene polyamine condensation products. The present invention mainly assumes an ink-jet recording medium for outdoor and indoor applications, and in particular, excellent durability such as heat resistance and water resistance, is required. These cationic components having good heat resistance (or heat yellowing resistance) and water resistance include allylamine, diallylamine, diallyldimethylammonium salt, dimethylaminoethyl methacrylate and dimethylaminoethyl acrylate. Among these cationic components, diallyldimethylammonium salt, dimethylaminoethyl methacrylate and dimethylaminoethyl acrylate are more advantageous. Although there is insufficient basis for theoretically explaining the influence of these cationic components on the durability of ink-jet printed materials, the present inventors actually used various cationic components in the ink-absorption layer, performed ink-jet printing, and carried out a durability test, thereby comparing the properties of those components and verifying that the above-mentioned cationic components are advantageous. However, it can be presumed from these empirical test results that cationic components, such as dimethylamine epihalohydrin condensation product and dicyandiamide polyalkylene polyamine condensation products, that contain cationic amines in their main chain of the polymer tend to have less durability such as resistance to heat and light. In contrast, it can be presumed that cationic components, such as allylamine cations and acrylate cations, that contain amines in their side chains tend to have a good balance of water resistance and heat resistance. In addition, it is also presumed that among amines, those (ammonium salts) in which the nitrogen atom is bonded to a plurality of alkyl and/or benzyl groups tend to be more difficult to change by heat and the like due to steric hindrance effect. For example, a diallyldimethylammonium salt used as the cationic component tends to confer better heat resistance than allylamine or diallylamine.

Meanwhile, allylamine cationic components, particularly diallyldimethylammonium salt, have excellent water resistance and good heat resistance. Acrylic cationic components have somewhat poor water resistance but they show excellent heat resistance. In the present invention, the ratio of the amount of use of an amphoteric fixer that contains a diallyldimethylammonium salt contained in the ink-absorption layer, to the amount of use of an amphoteric fixer that contains dimethylaminoethyl methacrylate or dimethylaminoethyl acrylate is preferably in the range between 5:1 and 1:5. Sufficient water resistance is not obtained if the amount of the allylic fixer is below this range, and sufficient heat resistance is not obtained if the amount of the acrylic fixer is lower than this range.

In addition to the cationic components described above, the amphoteric fixers used in the present invention use anionic components to have good dispersing performance of porous pigment in the coating material. These anionic components are typically sodium carboxylate or sodium sulfonate, and the present invention uses these compounds. Suitably, the molar ratio of the cationic component, including amine, to the anionic component in the fixer is in the range between 1:0.01 and 1:0.5. The more the ratio of the cationic component is reduced, the more the fixing performance of ink-jet ink is decreased, resulting in deterioration of water resistance. To the contrary, the more the ratio of the anionic component is reduced, the lower the dispersing effect of the porous pigment becomes.

While the present invention is mainly characterized by the use of such an amphoteric fixer, the amount of the fixer used is preferably in the range of 1 to 30% by weight of the solid content of said ink-absorption layer. If the use amount is below this range, the fixing performance of ink is deteriorated, while if the use amount is too large, the water resistance of the ink absorption layer per se is deteriorated. This is due to the water solubility of the fixer itself.

As described above, the ink-absorption layer is formed on the substrate by applying the coating material with a coating machine. Preparation of the coating material used for this purpose is performed by mixing the fixer and binder, appropriately diluting the mixture with water and the like, and stirring with a mixer. The mixer should be one with high dispersing efficiency, such as Colles's stirrers and high speed impeller stirrers. While stirring, a predetermined amount of porous pigment, such as silica, is added to the mixture. After the addition, the stirring is continued until sufficient dispersion of the pigment is obtained. Optionally, micro-dispersion may be obtained by using a stirring apparatus, such as Homomixer. Poor stirring may result in a high content of aggregates, which causes unevenness of the coated surface and reduce the storage stability of the coating material. To the contrary, excessive stirring may result in excessive grinding of the pigment which causes reduction in porosity of the ink-receiving layer and deteriorate the ink absorption. In general, silica is used as a porous pigment. This is, of course, due to the property of silica that facilitates formation of porous material. This is also due to the advantageous properties of silica, that it has a low refractive index, excellent transparency and excellent coloring quality in ink-jet printing. There are a variety of methods for synthesizing micropowder silica. For example, when gel-type silica is used, the secondary particles formed by aggregation of the primary particles form a porous material, and too strong stirring may disrupt the secondary particles.

The coating material thus prepared is applied to the substrate using a coating machine as described above. The amount of the coating material to be applied varies depending on substrate; however, it may preferably be in the range of 5 to 60 μm by thickness, more preferably in the range of 25-50 μm, given that an ink-impermeable material such as plastic film is used as the substrate. If the amount of coating material to be applied is too small, ink absorption performance is deteriorated and the water resistance is reduced. If the amount of coating material to be applied is too large, adhesion between the ink-receiving layer and substrate is decreased and the ink permeates deeper into the substrate, thereby blurring the print.

Since the substrate is reel fed during coating, other processing may be carried out, including slitting to adjust the width to fit the ink-jet printer and cutting by cutter into sheet.

Meanwhile, the ink-jet recording medium of the present invention mainly has industrial use, which is often in the indoor and outdoor environment, and the medium is required to have durability such as resistance to heat, water and light. Thus, optionally, a protection layer may be formed, after ink-jet printing, for the printed materials by laminating the printed materials with plastic film or coating the printed surface with a polymer component.

The present invention will be described below with reference to Examples. However, it should be understood that the embodiments of the present invention is by no means restricted to such specific Examples.

### EXAMPLE 1

As the materials for constituting the ink-absorption layer, silica micropowder with an average particle diameter of 7 μm and with oil absorption of 190 ml/100 g was used as a porous pigment; a polycarbonate polyurethane emulsion was used as the binder; and an amphoteric fixer containing a diallyldimethylammonium salt as the cationic component, and sodium carboxylate as the anionic component was used as the fixer. The molar ratio of the cationic component to the anionic component of the fixer was 1:0.1. The mixing ratio of the porous pigment, binder and fixer was 57:34:8.6 by weight.

Preparation of the coating material was performed as follows: a mixture of the fixer, binder and the necessary volume of water was stirred for 30 minutes in the Colles's stirrer, followed by addition of silica micropowder. On completion of the addition of silica, stirring was continued for additional 100 minutes. The solid concentration of this coating material was 41%. After stirring, the mixture was filtrated through a metal screen of 200 mesh to remove foreign materials, thereby obtaining the coating solution. The viscosity of this coating solution was 1500 mPa·s.

As the substrate, a polyethylene terephthalate film with a thickness of 100 μm that was subjected to adhesion treatment by means of corona treatment was used, which was coated with the coating solution by a roll-knife coater. The thickness of the coat at the time of application was 100 μm and 37 μm after drying.

After coating, the take-up roll was slitter processed using a slitter to the width of 1500 mm, thereby obtaining a take-up roll of ink-jet recording medium with 100 m in length.

This take-up roll was printed using a wide-format printer (manufactured by EPSON, PM-9000) in which aqueous ink is used and thereby obtaining a printed material.

Printing quality of the printed material was determined by visual observation. Water resistance of the printed material was determined by observing bleeding and discoloration of ink after soaking the printed material in water for 10 seconds. Heat resistance of the printed material was determined by visual observation of discoloration of ink and yellowing of unprinted portions after heat treatment at 190° C. for 30 minutes in the oven. The results of these examinations are shown in Table 1.

### EXAMPLE 2

The fixer used in Example 1 was replaced with the following materials. The fixer used in Example 1 is referred to as “fixer 1”. The fixer which uses dimethylaminoethyl methacrylate as the cationic component and sodium carboxylate as the anionic component at an each molar ratio of 1:0.2 is referred to as “fixer 2”. The fixers 1 and 2 were used at a ratio of 3:2 by weight. The binder used in Example 1 was replaced with an emulsion of polycarbonate polyurethane and ethylene-vinyl acetate copolymer. The composition ratio of polycarbonate polyurethane and ethylene-vinyl acetate copolymer of the emulsion was 22:12 by weight. A coating material was prepared identically as described above in Example 1 except the modifications described for this example. The solid concentration of the coating solution was 42%, and the viscosity of the coating solution was 1300 mPa·s. This coating solution was applied to the substrate in the same manner as described in Example 1, thereby obtaining an ink-jet recording medium. The thickness of the ink-receiving layer was 39 μm. This was examined by characterizing the printed material in the same manner as described in Example 1, and the results are shown in Table 1.

### EXAMPLE 3

A coating solution was obtained in a manner identical to that described in Example 1, except that the cationic component of the fixer used in Example 1 was replaced with allylamine. The solid concentration of this coating solution was 39%, and the viscosity of the coating solution was 1500 mPa·s. This coating solution was applied to the substrate in the same manner as described in Example 1, thereby obtaining an ink-jet recording medium. The thickness of the ink-receiving layer was 36 μm. This was examined by characterizing the printed material in the same manner as described in Example 1, and the results are shown in Table 1.

### EXAMPLE 4

A coating solution was obtained in a manner identical to that described in Example 1, except that the binders used in Example 2 were all replaced with ethylene-vinyl acetate copolymer. The solid concentration of this coating solution was 43%, and the viscosity of the coating solution was 1200 mPa·s. This coating solution was applied to the substrate in the same manner as described in Example 1, thereby obtaining an ink-jet recording medium. The thickness of the ink-receiving layer was 41 μm. This was examined by characterizing the printed material in the same manner as described in Example 1, and the results are shown in Table 1.

### EXAMPLE 5

A coating solution was obtained in a manner identical to that described in Example 2, except that the cationic component of fixer 2 used in Example 2 was replaced with dimethylaminoethyl acrylate. The solid concentration of this coating solution was 41%, and the viscosity of the coating solution was 1300 mPa·s. This coating solution was applied to the substrate in the same manner as described in Example 1, thereby obtaining an ink-jet recording medium. The thickness of the ink-receiving layer was 38 μm. This was examined by characterizing the printed material in the same manner as described in Example 1, and the results are shown in Table 1.

### COMPARATIVE EXAMPLE 1

A coating solution was prepared in a manner identical to that described in Example 1, except that the fixer contains a diallyldimethylammonium salt as the cationic component and no anionic component to Example 1. The solid content of the coating solution was set to 19%, and the viscosity of the coating solution was 2500 mPa·s, which is near the upperlimit for the application condition. This coating solution was treated in the same manner as described in Example 1, thereby preparing an ink-jet recording medium. The thickness of the ink-receiving layer was 15 μm. The printed material was characterized in the same manner as described in Example 1, and its characteristics are shown in Table 1.

### COMPARATIVE EXAMPLE 2

A coating solution was prepared in a manner identical to that described in Example 1, except that the molar ratio of the cationic component to anionic component of the fixer in Example 1 was set to 1:0.008. The concentration of the coating solution was 23%, and the viscosity of the coating solution at this concentration was 2000 mPa·s. An ink-jet recording medium was prepared using this coating solution in the same manner as described in Example 1. The thickness of the ink-receiving layer was 18 μm. Furthermore, this medium was printed by ink-jet printer and then characterized in the same manner as described in Example 1. Its characteristics are shown in Table 1.

### COMPARATIVE EXAMPLE 3

A coating solution was prepared in a manner identical to that described in Example 1, except that the molar ratio of the cationic component to anionic component of the fixer in Example 1 was set to 1:0.6. The concentration of the coating solution was 44%, and the viscosity of the coating solution at this concentration was 1700 mPa·s. An ink-jet recording medium was prepared using this coating solution in the same manner as described in Example 1. The thickness of the ink-receiving layer was 40 μm. Furthermore, this medium was printed by ink-jet printer and then characterized in the same manner as described in Example 1. Its characteristics are shown in Table 1.

### COMPARATIVE EXAMPLE 4

A coating solution was prepared in a manner identical to that described in Example 1, except that the use amount of the fixer in Example 1 was set to 0.5% by weight of the solid content of the ink-receiving layer. The concentration of the coating solution was 23%, and the viscosity of the coating solution was 1800 mPa·s. An ink-jet recording medium was prepared using this coating solution in the same manner as described in Example 1. The thickness of the ink-receiving layer was 18 μm. Furthermore, this medium was printed by ink-jet printer and then characterized in the same manner as described in Example 1. Its characteristics are shown in Table 1.

### COMPARATIVE EXAMPLE 5

A coating solution was prepared in a manner identical to that described in Example 1, except that the use amount of the fixer in Example 1 was set to 35% by weight of the solid content of the ink-receiving layer. The concentration of the coating solution was 43%, and the viscosity of the coating solution was 1600 mPa·s. An ink-jet recording medium was prepared using this coating solution in the same manner as described in Example 1. The thickness of the ink-receiving layer was 39 μm. Furthermore, this medium was printed by ink-jet printer and then characterized in the same manner as described in Example 1. Its characteristics are shown in Table 1.

### COMPARATIVE EXAMPLE 6

A coating solution was prepared in a manner identical to that described in Example 1, except that the type of the fixer in Example 1 changed to a dimethylamine epichlorohydrin condensation product. The concentration of the coating solution was 18%, and the viscosity of the coating solution in this condition was 1300 mPa·s. An ink-jet recording medium was prepared using this coating solution in the same manner as described in Example 1. The thickness of the ink-receiving layer was 13 μm. Furthermore, this medium was printed by ink-jet printer and then characterized in the same manner as described in Example 1. Its characteristics are shown in Table 1.

Table 1

| | | | | Concen- | | | | |
|---|---|---|---|---|---|---|---|---|
| | Fixer | | | tration | Thickness of | Characteristics of printed matter | | |
| | | Anionic | | of coating | ink-receiving | Image | Water | Heat |
| | Cationic component | component | Binder | material | layer | quality | resistance | resistance |
| Example 1 | Diallyldimethylamine | Sodium | Polycarbonate | 41% | 37 μm | ⊚ | ◯ | ◯ |
| | | carboxylate | polyurethane | | | | | |
| Example 2 | 1: Diallyldimethylamine | Sodium | 1: Polycarbonate | 42% | 39 μm | ⊚ | ◯ | ⊚ |
| | 2: Dimethylaminoethyl | carboxylate | polyurethane | | | | | |
| | methacrylate | | 2: Ethylene-vinyl | | | | | |
| | | | acetate copolymer | | | | | |
| Example 3 | Allylamine | Sodium | Polycarbonate | 39% | 36 μm | ◯ | ◯ | Δ |
| | | carboxylate | polyurethane | | | | | |
| Example 4 | 1: Diallyldimethylamine | Sodium | Ethylene-vinyl | 43% | 41 μm | ◯ | Δ | ◯ |
| | 2: Dimethylaminoethyl | carboxylate | acetate copolymer | | | | | |
| | methacrylate | | | | | | | |
| Example 5 | 1: Diallyldimethylamine | Sodium | 1: Polycarbonate | 41% | 38 μm | ⊚ | ◯ | ◯ |
| | 2: Dimethylaminoethyl | carboxylate | polyurethane | | | | | |
| | acrylate | | 2: Ethylene-vinyl | | | | | |
| | | | acetate copolymer | | | | | |
| Comp. Example 1 | Diallyldimethylamine | None | Polycarbonate | 19% | 15 μm | X | X | ◯ |
| | | | polyurethane | | | | | |
| Comp. Example 2 | Diallyldimethylamine | Sodium | Polycarbonate | 23% | 18 μm | X | X | ◯ |
| | | carboxylate | polyurethane | | | | | |
| Comp. Example 3 | Diallyldimethylamine | Sodium | Polycarbonate | 44% | 40 μm | ◯ | X | ◯ |
| | | carboxylate | polyurethane | | | | | |
| Comp. Example 4 | Diallyldimethylamine | Sodium | Polycarbonate | 23% | 18 μm | X | X | ◯ |
| | | carboxylate | polyurethane | | | | | |
| Comp. Example 5 | Diallyldimethylamine | Sodium | Polycarbonate | 43% | 39 μm | X | Δ | ◯ |
| | | carboxylate | polyurethane | | | | | |
| Comp. Example 6 | Dimethylamine | None | Polycarbonate | 18% | 13 μm | X | X | X |
| | epichlorohydrin | | polyurethane | | | | | |
| | condensation product | | | | | | | |

Evaluation criteria: by visual inspection ⊚ Excellent, ◯ Good, Δ Acceptable, X Poor

What is claimed is:

1. An ink-jet recording medium comprising at least one ink-receiving layer provided on at least one surface of the substrate for receiving ink during ink jet printing, wherein an ink-absorption layer which is one of the layers constituting said ink-receiving layer and which absorbs the largest amount of ink is composed of a material comprising porous pigment, a fixer and a binder, wherein said fixer is an amphoteric fixer containing a cationic component that is cationic and an anionic component that is anionic, wherein the molar ratio of an amount of said cationic component to an amount of said anionic component contained in said fixer is in the range between 1:0.01 and 1:0.5, and wherein the percentage of said fixer contained in said ink-absorption layer ranges from 1 to 30% by weight of the solid content of said ink-absorption layer.

2. The ink-jet recording medium of claim 1, wherein said cationic component is at least one selected from the group consisting of diallyldimethyl ammonium salt, allylamine, dimethylaminoethyl methacrylate and dimethylaminoethyl acrylate.

3. The ink-jet recording medium of claim 2, wherein said cationic component is selected from a group consisting of diallyldimethyl ammonium salt, dimethylaminoethyl methacrylate and dimethylaminoethyl acrylate, wherein said fixer is a mixture of a first fixing agent containing a diallyldimethyl ammonium salt as a cationic component and a second fixing agent containing either dimethylaminoethyl methacrylate or dimethylaminoethyl acrylate as a cationic component, and wherein the mixing ratio of said first and second fixing agents is in the range between 5:1 and 1:5 by weight.

4. The ink-jet recording medium of claim 1, wherein said ink-absorption layer contains a polycarbonate polyurethane resin as said binder at a ratio of 5 to 50% by weight of the solid content of said ink-absorption layer.
